(19) United States
(12) Patent Application Publication
(10) Pub. No.: US 2005/0128293 A1
(43) Pub. Date: Jun. 16, 2005

(54) Video records with superimposed information for objects in a monitored area

(75) Inventors: Philip A. Wilsey, Cincinnati, OH (US); Fred R. Beyette JR., Cincinnati, OH (US); Darryl S. Dieckman, Cincinnati, OH (US); Dale E. Martin, Cincinnati, OH (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: Clifton Labs, Inc., Cincinnati, OH (US)

(21) Appl. No.: 10/997,124

(22) Filed: Nov. 24, 2004

Related U.S. Application Data
(63) Continuation-in-part of application No. 10/725,250, filed on Dec. 1, 2003.

(51) Int. Cl. H04N 7/18

(52) U.S. Cl. 348/143; 235/375; 235/487; 340/572.1

(57) ABSTRACT

Described are a method and system for providing information into a video record from an object in a monitored area. A video image of the monitored area is generated and information is received in a signal transmitted from the object. An image is displayed which shows the information superimposed on the video image. Optionally, the displayed image shows the information at a location in a display that corresponds to a location of the object in the display. The displayed image can include an automatic scrolling of the information overlaid on the video image or an automatic or manual scrolling of the information in a region adjacent to a region showing the video image.

### CROSS-REFERENCE TO RELATED APPLICATIONS

This application is a continuation-in-part application claiming priority to co-pending U.S. patent application Ser. No. 10/725,250, filed Dec. 1, 2003, titled “Optical Asset Tracking System,” the entirety of which application is incorporated by reference herein.

### FIELD OF THE INVENTION

The invention relates generally to monitoring a defined area. More particularly, the invention relates to a method and system for providing information into a video record from an object in the monitored area.

### BACKGROUND

The location and status of assets and other objects can be determined using different means of object tracking. For example, equipment, inventory and personnel can be tracked so that their position, status and related information can be determined at different times. Presentation of this information to a user, however, is generally limited to a text and numerical display of the information. Consequently, a user of a tracking system cannot easily and quickly associate the displayed information with the corresponding tracked objects. Moreover, as the location of an object changes over time, it generally becomes more difficult for the user to associate the corresponding information with the object. The difficulty grows as the number of objects being tracked increases.

Video cameras are often used to observe the location of objects in the field of view of the camera. Although the video record allows a user to quickly determine the presence and location of an object within the monitored area, there is no means to display other information associated with the object such as measurement data generated at the object. Moreover, objects having a similar appearance cannot be readily distinguished in the video image.

The present invention overcomes the problems identified above and provides additional advantages.

### SUMMARY OF THE INVENTION

In one aspect the invention features a method for providing information into a video record from an object in a monitored area. A video image of the monitored area is generated and the information is received from a signal transmitted from the object. An image is displayed which shows the information superimposed on the video image. In one embodiment, the displayed image shows the information at a location in a display responsive to a location of the object in the display.

In another aspect the invention features a system for providing information into a video record from an object in a monitored area. The system includes a video image sensor to generate a video image of the monitored area and a receiver to detect a signal transmitted from the object and having the information. The system also includes a processor in communication with the video image sensor and the receiver. The processor generates image data for an image showing the information superimposed on the video image.

In another aspect the invention features a system for providing information into a video record from an object in a monitored area. The system includes a sensor having a plurality of pixels. Each pixel is configured to generate an electrical signal in response to an optical data signal emitted by an optical tag and incident on the pixel. The plurality of pixels provides video image data for the monitored area. The system also includes a processor in communication with the sensor. The processor determines the information from at least one of the electrical data signals and generates image data for an image that shows the information superimposed on the video image.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is a block diagram illustration of an embodiment of an optical asset tracking system in accordance with the invention.

FIG. 2 is a functional block diagram of the sensor and sensor processor of FIG. 1.

FIG. 3 is a functional block diagram of a sensor and a sensor processor according to another embodiment of an optical asset tracking system in accordance with the invention.

FIG. 4 is a block diagram of another embodiment of an optical asset tracking system in accordance with the invention.

FIG. 5 illustrates an optical communications imager used to monitor assets in a room in accordance with an embodiment of the invention.

FIG. 6 is a block diagram of an embodiment of an optical tag constructed in accordance with the invention.

FIG. 7 is a schematic diagram of an embodiment of an optical tag constructed in accordance with the invention.

FIG. 8 is a functional block diagram of an embodiment of a system for providing information into a video record from an object in a monitored area in accordance with the invention.

FIG. 9 is an illustration showing information transmitted from monitored objects and superimposed on a video image of a monitored area according to an embodiment of the invention.

FIG. 10 is an illustration of the image of FIG. 9 at a later time.

FIG. 11 is an illustration showing information transmitted from monitored objects superimposed on a video image of a monitored area according to another embodiment of the invention.

FIG. 12 is an illustration showing information transmitted from monitored objects and superimposed on a video image of a monitored area according to another embodiment of the invention.

### DETAILED DESCRIPTION

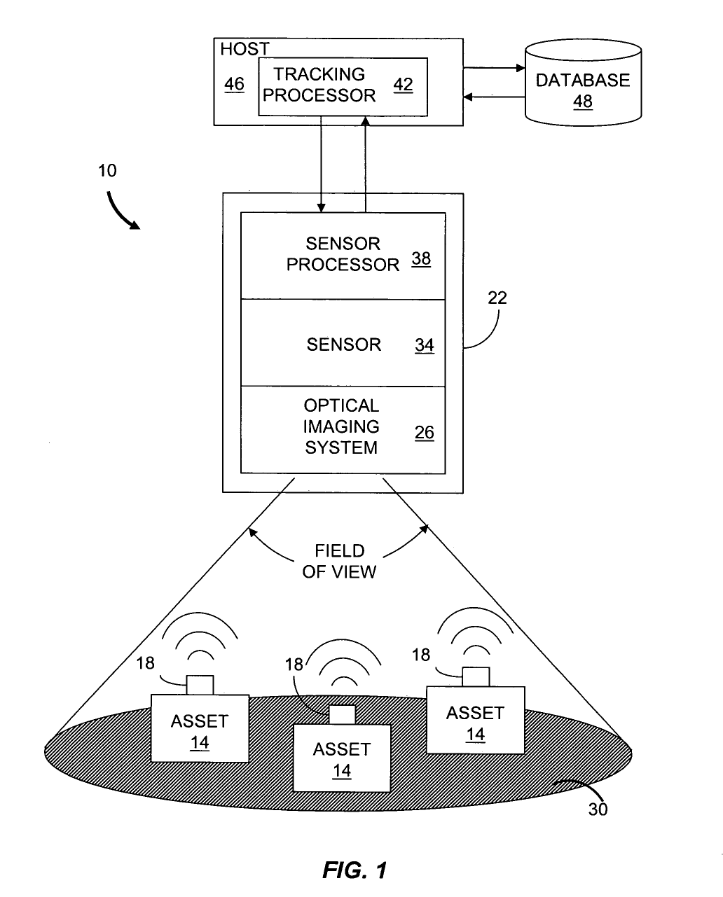

FIG. 1 is a block diagram illustrating an embodiment of an optical asset tracking system 10 according to the present invention. Affixed to each asset 14 is an optical tag 18 that includes an optical modulator, such as an optical source (e.g., light emitting diode (LED) or laser) or a modulated reflector. The optical modulator transmits asset data by way of an optical signal to an optical communications imager 22. The optical communications imager 22 includes an optical imaging system 26 to generate an image of a monitored area 30, or tracking region, on a sensor 34 having an array of pixels. Each pixel includes circuitry to receive high-speed optical communications data and to contribute data for generation of a video signal. The optical communications imager 22 also includes a sensor processor 38 for extracting the data in one or more optical signals incident on the array of pixels. Thus the optical asset tracking system can track a significant number of assets 14 within its field of view. The above described implementation of an optical communications imager is described in U.S. patent application Ser. No. 10/306,555, filed Nov. 27, 2002, titled “Optical Communications Imager” and U.S. patent application Ser. No. 10/305,626, filed Nov. 27, 2002, titled “Optical Communications Imager,” which are incorporated by reference herein in their entirety.

A tracking processor 42 embedded in a host computer 46 communicates with the sensor processor 38 to receive the pixel data. The host computer 46 can be local to the optical communications imager 22 or it can be at a remote location, such as a different room or building. The tracking processor 42 determines the asset data and asset location information for each asset 14 in the field of view of the optical communications imager 22, and generates asset tracking information. The sensor processor 38 and the tracking processor 42 can be implemented in any device or circuitry used to process data to achieve the desired functionality. In one embodiment the sensor processor 38 and the tracking processor 42 are integrated as a single processor providing both sensor and tracking functionality. In other embodiments the sensor processor 38 and the tracking processor 42 are implemented as dedicated electronic circuits. In still other embodiments the sensor processor 38 and tracking processor 42 do not employ optical technology. For example, the sensor processor 38 can receive an RFID signal or a wireless data signal, and provides processed data to the tracking processor 42 for determination of asset data and asset location.

A tag tracking database 48 keeps track of the current location and status of each tag used in the optical asset tracking system 10. Asset locations recorded in the tracking database 48 can be retrieved to determine where the asset 14 was located at various times. Environmental conditions and aging information can be recorded so that any assets 14 having limited usefulness based on environmental exposure or age can be located and used before similar assets 14 having a longer lifetime. The tracking database 48 can be queried to quickly determine the location of an asset 14 having infrequent utilization. In one embodiment asset data stored in the tag tracking database 48 is referenced to corresponding video data generated by the optical communication imager. For example, an individual tampering with an asset 14 can be viewed on video with corresponding asset data overlaid on the video display as described in more detail below.

In other embodiments of the optical asset tracking system 10, the tracking functionality is integrated with the optical communications imager 22. For example, asset identification can be performed by a processor co-located with the optical communications imager 22. Additionally, an integrated alarm can be activated in response to assets 14 being moved within or removed from the monitored area 30.

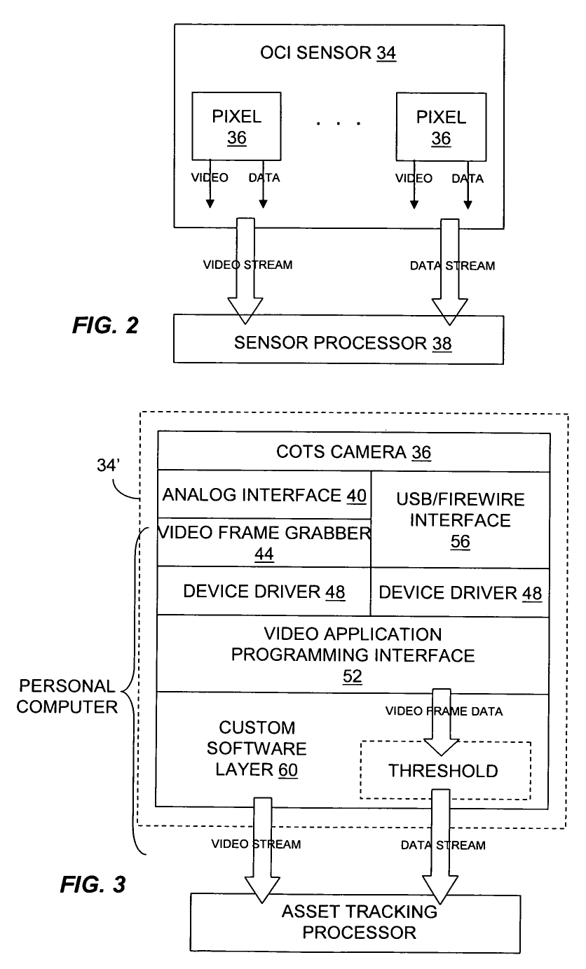

FIG. 2 illustrates the functionality of various components of the optical communications imager 22 depicted in FIG. 1. Each pixel 36 in the sensor 34 generates a video signal and communications data. The video signals from the pixels 36 are multiplexed into a video data stream and provided to the sensor processor 38. Similarly, the communications data from the pixels 36 are multiplexed into a communications data stream and provided to the sensor processor 38. Asset tracking functionality is implemented in the sensor processor 38, or may be implemented with an additional processing module.

FIG. 3 illustrates a portion of an embodiment of an optical asset tracking system in which commercially-available components replace the sensor 34 and sensor processor 38 of the optical communications imager 22 of FIG. 1. The sensor 34′ includes a commercial off the shelf (COTS) video camera 36 for generating an analog or digital video signal. If an analog video camera is employed, an analog interface 40, video frame grabber 44 and device driver 48 are used to generate digital data, i.e., video frame data, which can be manipulated with a video application programming interface 52, such as Video for Windows or Video4Linux. Alternatively, if a digital video camera is used, a digital interface 56 employing, for example, the USB (Universal Serial Bus) or Firewire standard, and a device driver 48 are used to provide the video frame data to the video application programming interface 52. An additional software component 60 separates the video frame data into a video stream and a data stream similar to the video and data streams of the sensor 34 of FIGS. 1 and 2. The data stream is determined, for example, by comparing the intensity value from each pixel to a threshold value to determine whether an optical bit is present during the video frame. Subsequent processing of the video and data streams for asset tracking is similar.

An important difference between the sensor 34 for the optical communications imager 22 and the sensor 34′ fabricated from commercially-available components is that the communications data rate of the latter is limited to the frame rate of the camera 36. More specifically, the camera 36 does not provide communications data in the conventional sense; however, a single pixel can support communications for data rates that do not exceed the frame rate. Thus the communications data rate is less by orders of magnitude. In applications where data transfer between assets 14 and the sensor 34 are low, the asset tracking system 10′ constructed from commercial components is preferred based on its substantially lower cost.

Advantageously, the optical asset tracking system 10 of the invention is not affected by electromagnetic interference (EMI) sources, such as electric motors and machinery, because optical signals are utilized. Furthermore, the data transmitted from the optical tags 18 is not vulnerable to eavesdropping by parties outside the room or building in which the assets 14 are located.

The asset data and tracking information generated by the optical asset tracking system 10 can be shared with other resources such as enterprise management tools and planning systems, and the asset tracking data can be used for a wide range of purposes. By way of example, assets 14 that can be tracked include factory equipment, vehicles, valuable items, employees, hospital patients and the like. Employees can be tracked by attaching an optical tag to a badge worn on the employee's clothing. Room lights, electrical power, automatic doors, safety equipment, security equipment and utilities can be activated or deactivated according to the location of the employee. Similarly, optical tags can be attached to hospital patients using wrist bands, badges and the like. Alternatively, an optical tag can be integrated into a bandage that can be affixed directly to the skin. The optical tag can record the health status, health history and medical treatment history of the patients. Items having critical time and environmental sensitivity, such as human organs and blood, can be tracked. For example, a human organ can be tracked from its point of harvest to its point of insertion. Environmental sensors can be attached to the organ carrier to record environmental parameters during transport. The recorded data can be broadcast during transport to confirm that the organ is not exposed to unsatisfactory conditions.

Optical broadcast of the recorded information may be continuous or can be initiated in response to an interrogation signal received by the optical tag. Alternatively, periodic or continuous broadcast of general patient information can occur with detailed patient information being broadcast in response to the interrogation signal. In one example, the optical tag includes one or more sensors to monitor a physical parameter associated with the health of the patient. If it is determined that a physical parameter crosses an associated threshold value, the optical tag automatically initiates a broadcast of patient information to the optical communications imager 22. In another example, devices having critical maintenance schedules or usage limitations can be tracked. For example, a blood distribution unit can be interrogated to determine its use history and current delivery rate.

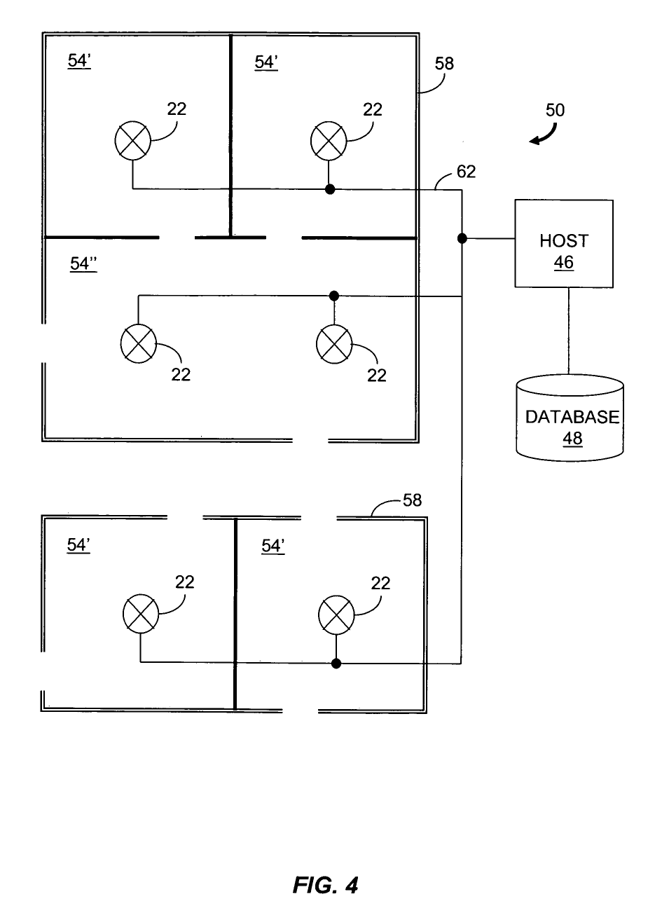

FIG. 4 illustrates an embodiment of an optical asset tracking system 50 according to the invention in which multiple optical communication imagers 22 are deployed in multiple rooms 54′, 54″ (generally 54) of separate buildings 58. The buildings 58 can be located in an office park or campus environment. Alternatively, the buildings can be geographically separated by a few miles or by thousands of miles. Although only two buildings 58 are illustrated, it should be recognized that the principles of the invention apply to optical asset tracking systems having optical communications images installed in any number of buildings.

Each optical communications imager 22 observes a monitored area 30 (see FIG. 1) that potentially includes one or more assets 14 to be tracked. The monitored area 30 preferably includes all of the floor space of a room 54, however, depending on the type of assets 14 to be tracked, only a portion of a room 54′ may be included in the monitored area 30. In the illustrated embodiment, two optical communications imagers 22 are used to monitor a single large room 54″. The fields of view of the two optical communications imagers 22 in the large room 54″ can be distinct. Conversely, the fields of view can overlap if a gap between the corresponding monitored areas 30 is unacceptable. The optical communication imagers 22 in the optical asset tracking system 50 are coupled via a network 62, such as a wired Ethernet, RF, infrared (IR) or optical fiber based network, to a host computer 46, such as a personal computer (PC), in communication with a tag tracking database 48.

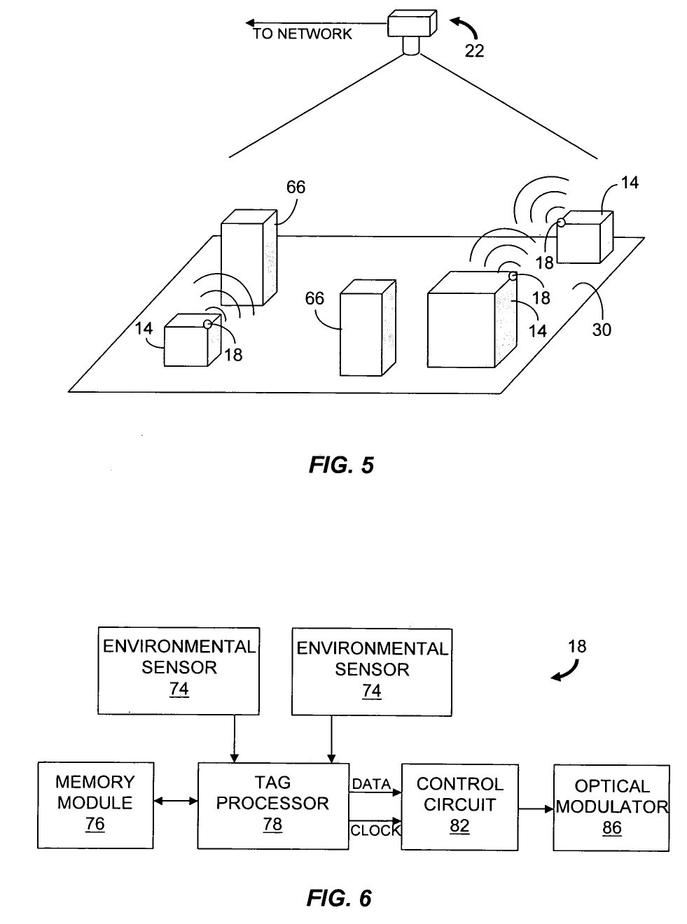

FIG. 5 depicts the optical communications imager 22 used to monitor assets 14 in a room 54′. An optical tag 18 is attached to each asset 14 to be tracked in a location that permits the optical signal to propagate unobstructed to the optical communications imager 22. For example, it is preferable to mount an optical tag 18 to the top of the asset 14 if the line of sight between the asset 14 and the optical communications imager 22 might otherwise be blocked by the asset 14 or other assets 14 and structures 66 in the room.

Optical tags 18 can take on a variety of forms. For example, an optical tag 18 can include an optical source that includes an LED or a laser that emits an optical signal at regular intervals. If it is important to constantly monitor the location of the assets 14, the optical source continuously emits the optical signal. In one embodiment the optical tag 18 includes a tag processor, a memory module and one or more sensors to monitor environmental parameters (e.g., temperature and g-forces). The memory module stores the data generated by the sensor. Broadcasts of optical data can include raw sensor data and processed sensor data, such as the minimum, maximum and average of one or more of the parameter values determined after the previous broadcast. In another embodiment the memory is provided by the asset 14. The data stored in the asset memory is provided to the optical tag 18 through an interface module (e.g., RS/232, 12C, USB, Ethernet or Firewire) on the asset 14. Thus the optical tag 18 serves as a communication relay between the asset 14 and the host system 46 and database 48.

Broadcasts of asset data can be periodic or continuous, as described above, or broadcasts can be initiated on-demand. Periodic and on-demand broadcasting are preferred over continuous broadcasting in many applications to improve battery life. In an example of on-demand broadcasting, asset data is transmitted by manually activating a switch or button on the optical tag 18. Alternatively, the optical tag 18 includes an RF sensor, optical detector or acoustic sensor to receive an RF interrogation signal, optical interrogation signal or acoustical interrogation signal, respectively. In one embodiment the interrogation signal includes security data which is examined by the optical tag 18 to ensure the validity of the interrogation request. The optical tag 18 initiates a broadcast upon detection of the interrogation signal. In another embodiment broadcasting is triggered when an environmental condition is changed or crosses a predetermined threshold value. For example, broadcasting can be initiated when movement of the asset is detected, when the ambient temperature increases (or decreases) to a predetermined temperature or when acoustic noise exceeds a predetermined level.

Asset data broadcasts can be automatically initiated. For example, if a tag processor determines that one of the monitored environmental parameters exceeds a threshold value, an immediate broadcast of the asset data is initiated. In another example, a motion detector integrated with the optical tag 18 initiates broadcasting if the asset 14 moves.

The information content broadcast by the optical tag 18 can vary. For example, an optical tag 18 can broadcast a limited data set at one broadcast interval and a larger data set at a longer broadcast interval. In another example, the optical tag 18 broadcasts limited data at regular intervals and detailed data for on-demand broadcasts or when a monitored parameter crosses a threshold.

FIG. 6 is a functional block diagram of one embodiment of an optical tag 18 constructed according to the invention. The optical tag 18 includes any number of environmental sensors 74 in communication with a tag processor 78. A memory module 76 provides for temporary storage of raw data and processed data for possible broadcast. The memory module 76 can also store unique identification data associated with the asset to which it is attached. The tag processor 78 receives and processes the environmental data, and sends the processed data, a clock signal, and the identification data to a control circuit 82. In response, the control circuit 82 generates a control signal for generating the optical data signal at an optical modulator 86. In one embodiment the optical modulator 86 is an optical source. In an alternative embodiment the optical modulator 86 is a modulated reflector which modulates an incident optical signal or ambient light in response to the asset data to be transmitted. The environmental sensors 74 can include temperature sensors, optical detectors, pressure sensors, and any device that can detect an environmental parameter and generate a corresponding electrical signal.

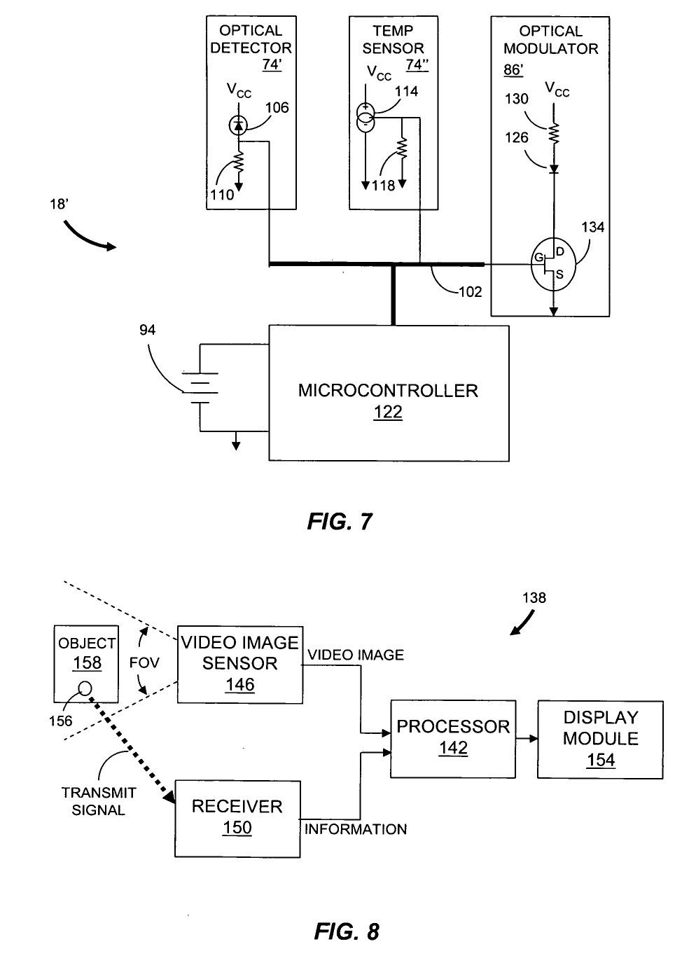

FIG. 7 is a detailed illustration of an embodiment of an optical tag 18′ constructed in accordance with the present invention. A battery 94 supplies power for various components of the tag 18′. Environmental sensors 74 include an optical detector 74′ and a temperature sensor 74″ which communicate with a microcontroller 98 via a data bus 102. The optical detector 74′ includes a photodiode 106 and resistive component 110 that produce an output current proportional to incident light and the temperature sensor 74″ includes a transducer 114 and resistive component 118 that produce an output current proportional to temperature. In the illustrated embodiment the tag processor 78 is a microcontroller 122 (e.g., 8-bit CMOS microcontroller model no. PIC12C67X manufactured by Microchip Technology Inc.) having multiple analog-to-digital (A/D) channels and embedded data memory. A clock signal generated by the microcontroller 122 is used to trigger broadcasts of asset data at predetermined intervals. The optical modulator 86 includes an LED 126 in series with a resistive component 130. The LED 126 has an output power and wavelength selected according to the spectral sensitivity of the optical communications imager sensor 34 and the geometry of the monitored area 30. To generate the optical signal, the LED current is modulated by a control signal applied to the gate of an N-channel field effect transistor (FET) 134.

In an alternative embodiment the LED 126, resistive component 130 and FET 134 shown in FIG. 7 are replaced with a modulated reflector and control circuit. An incident optical beam is intensity modulated according to the asset data to be transmitted to the optical communications imager 22. In another embodiment the incident optical beam is an optical interrogation signal.

The number of assets in a monitored area can vary over time. Moreover, the position of the assets within the monitored area can change. Consequently, the presentation of asset data in a display can be confusing to a user of a tracking system. More generally, the problem extends to the reception and display of information transmitted from one or more objects in the monitored area.

FIG. 8 shows a block diagram illustrating an embodiment of a system 138 for providing information into a video record from an object in the monitored area according to the invention. The system 138 includes a processor 142 in communication with a video image sensor 146, a receiver 150 and a display module 154. For example, the video image sensor 146 and the receiver 150 are implemented as part of the optical communications imager of FIG. 1. In another example, the video image sensor 146 and the receiver 150 are implemented as described for the sensor 34′ of FIG. 3.

The video image sensor 146 generates a video image of the monitored area as defined by a sensor field of view (FOV). A transmitter 156 attached to an object 158 transmits a signal having information associated with the object 158. The signal can be any of a variety of types such as an optical data signal, an RFID signal emitted from an RFID tag on the object 158, a wireless data signal (e.g., IEEE 802.11 formatted signal), an optical signal generated in response to illumination of an optical barcode on the object 158, or an electrical signal transmitted over a conductive path originating at the object 158. Information from the transmitted signal detected at the receiver 150 is provided to the processor 142 along with the video image from the video image sensor 146. Image data generated by the processor 142 is provided to the display module 154. The resulting displayed image shows at least a portion of the information transmitted from the object 158 superimposed on the video image.

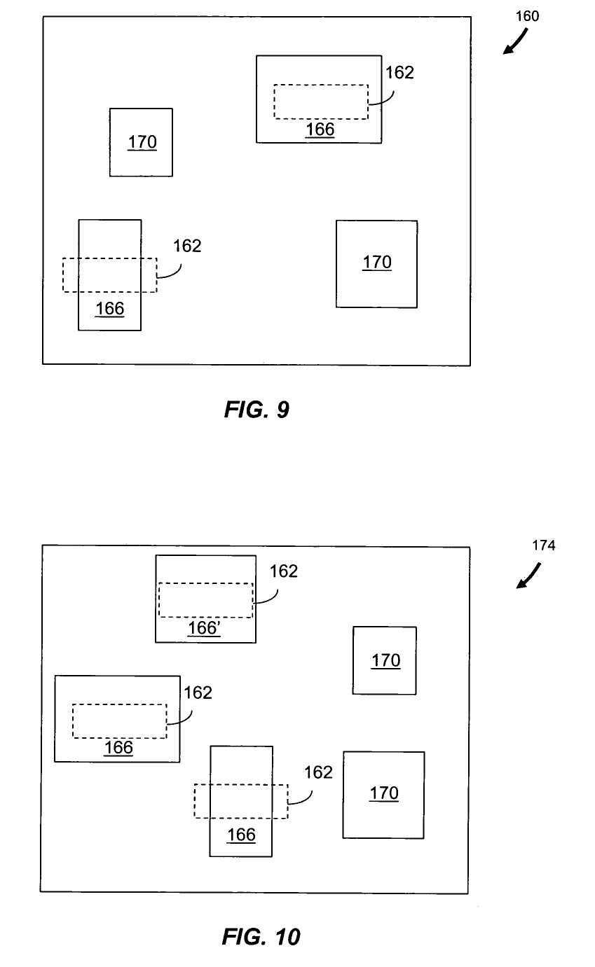

FIG. 9 illustrates an example of an image 160 showing displayed information 162 superimposed on a video image of a monitored area according to the invention. The displayed information 162 includes at least a portion of the information transmitted from two monitored objects 166. The image 160 includes objects equipped with transmitters (i.e., monitored objects 166) and two objects 170 without transmitters. The monitored objects 166 can include tracked assets that transmit parameters such as asset identification data and can include equipment tracked and monitored to determine a variety of information such as identification data, operational status and measurement data. Operational status includes maintenance information and equipment capacity information such as a remaining volume of a liquid resource, remaining battery charge, and the like. Measurement data includes data generated by various instruments and sensors. Measurement data includes, by way of example, environmental data (e.g., temperature, barometric pressure and humidity) and medical data (e.g., heart rate, electrocardiogram (EKG) signal data, blood pressure and drug pump rate).

In one embodiment, the transmitted information is compared with external information to generate referenced information to be superimposed on the image. For example, local positioning information can be referenced to (GPS) coordinates for the monitored area and precise GPS coordinates of the monitored objects 166 can be shown in the image 160. In another embodiment, the image 160 includes GPS coordinates superimposed in the video image of the monitored area.

The monitored objects 166 may transmit video image data or communication data. For example, a monitored object 166 can be equipped with a video image sensor to provide image data for a small region of the monitored area near the monitored object 166.

The information can be transmitted directly, i.e., as data generated by one or more sensors on the monitored objects 166. Alternatively, “raw” information generated at the monitored objects 166 can be processed prior to transmission. Processed information can include minimum, maximum and average values of sensed parameters for a known time interval. The information can be generated and transmitted from the monitored objects 166 without delay. Alternatively, information can be generated and stored at the monitored objects 166, and transmitted at a later time.

Displayed information 162 (designated by dashed rectangular boxes) is displayed in the form of text comprising alphanumeric characters. As illustrated, the displayed information 162 is positioned in the image 160 to overlay the corresponding monitored object 166. In an alternative embodiment, the displayed information 162 includes video data generated at one or more monitored objects 166 which is displayed as sub-images within the image 160. In another embodiment, the displayed information 162 includes a combination of video data and text for display with the monitored objects 166.

FIG. 10 illustrates an image 174 of the monitored area at a later time. The objects 166, 170 have been moved from their positions shown in FIG. 9 and a third monitored object 166′ has entered the monitored area. The displayed information 162 “tracks” the position of the corresponding monitored object 166, i.e., the position of the displayed information 162 is responsive to the position of the corresponding monitored object 166 in the image 174. Advantageously, an observer can quickly associate the displayed information 162 with a monitored object 166 without the need to reference a prior image.

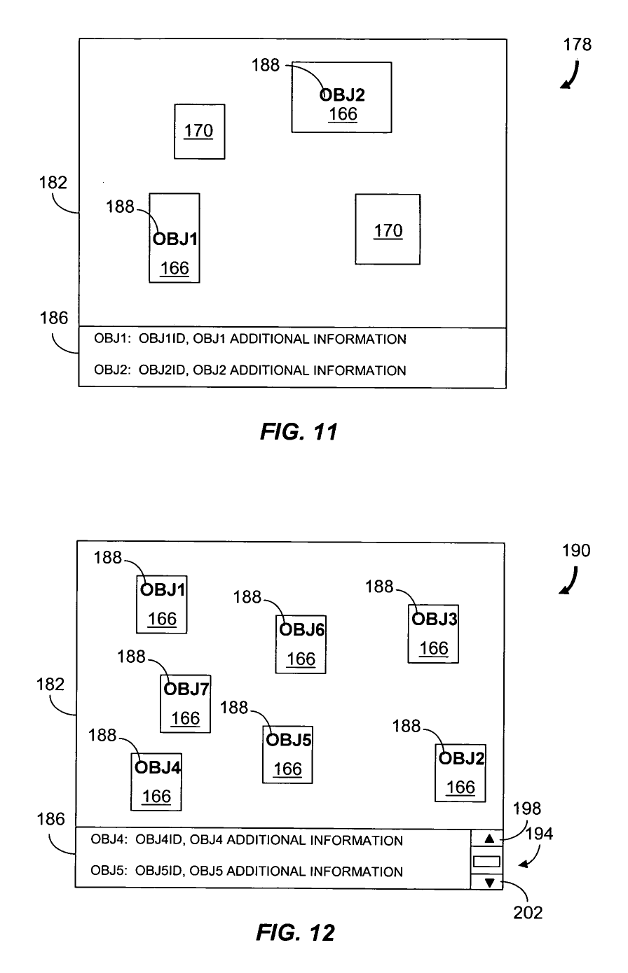

FIG. 11 shows an image 178 that includes a video region 182 and an adjacent information region 186 according to an embodiment of the invention. Monitored objects 166 in the video region 182 are overlaid with an alphanumeric identifier 188 (e.g., OBJ1, OBJ2). The information region 186 presents these identifiers 188 alongside additional alphanumeric information (e.g., measurement data) for the corresponding monitored object 166. The information is updated dynamically according to the signals transmitted from the monitored objects 166. The presentation of the alphanumeric information can be static such that all information in the information region 186 is continuously visible between information update cycles. Alternatively, the alphanumeric information can be automatically scrolled across the information region 186. Scrolling can be useful, for example, if the quantity of information to be displayed is too large to be simultaneously presented to an observer in the information region 186.

FIG. 12 illustrates an image 190 that includes a video region 182 showing seven monitored objects 166 (OBJ1 through OBJ7). Due to the large number of monitored objects 166, it is desirable to limit the information presented in the information region 186 for ease of viewing. In this embodiment, the information region 186 includes a scroll bar 194 enabling a user to manually scroll the available information. As illustrated, only information for monitored objects 166 OBJ4 and OBJ5 are shown. Using an input device (e.g., a “mouse”), a user can select the scroll-up arrow 198 to view the information for monitored objects 166 OBJ1 through OBJ3. Similarly, the user can select the scroll-down arrow 202 to view the information for monitored objects 166 OBJ6 and OBJ7.

While the invention has been shown and described with reference to specific preferred embodiments, it should be understood by those skilled in the art that various changes in form and detail may be made therein without departing from the spirit and scope of the invention as defined by the following claims.

1. A method for providing information into a video record from an object in a monitored area, the method comprising:
generating a video image of the monitored area;
receiving the information from a signal transmitted from the object; and
displaying an image showing the information superimposed on the video image.

2. The method of claim 1 further comprising transmitting the signal from the object.

3. The method of claim 1 wherein the signal comprises an optical data signal emitted from an optical tag on the object.

4. The method of claim 1 wherein the signal comprises an RFID signal emitted from an RFID tag on the object.

5. The method of claim 1 wherein the signal is a wireless data signal in compliance with an IEEE 802.11 communication standard.

6. The method of claim 1 wherein the signal is an optical barcode signal.

7. The method of claim 1 wherein the signal is transmitted over a conductive path originating at the object.

8. The method of claim 1 wherein the information comprises identification data.

9. The method of claim 1 wherein the information comprises monitoring data.

10. The method of claim 1 wherein the information comprises video image data.

11. The method of claim 1 wherein displaying an image showing the information superimposed on the video image comprises displaying an image showing the information at a location in a display responsive to a location of the object in the display.

12. The method of claim 1 wherein the information comprises information generated at the time of the generation of the video image.

13. The method of claim 1 wherein the information comprises information generated at a time prior to the generation of the video image.

14. The method of claim 1 wherein the information comprises processed information generated by processing raw information provided at the object prior to the transmission of the signal from the object.

15. The method of claim 1 wherein the image comprises an automatic scrolling of the information overlaid on the video image.

16. The method of claim 1 wherein the image comprises a region of automatic scrolling of the information adjacent to a region showing the video image.

17. The method of claim 1 wherein the image comprises a region for manual scrolling of the information adjacent to a region showing the video image.

18. The method of claim 1 further comprising comparing the information with external information to generate referenced information and wherein displaying an image comprises displaying an image showing the referenced information superimposed on the video image.

19. The method of claim 18 wherein the external information comprises GPS data

20. The method of claim 1 wherein the information comprises asset identification data.

21. The method of claim 1 wherein the information comprises environmental data.

22. The method of claim 1 wherein the information comprises medical data.

23. The method of claim 1 wherein the information comprises communication data.

24. A system for providing information into a video record from an object in a monitored area, comprising:
a video image sensor to generate a video image of the monitored area;
a receiver to detect a signal transmitted from the object and having the information; and
a processor in communication with the video image sensor and the receiver, the processor generating image data for an image showing the information superimposed on the video image.

25. The system of claim 24 further comprising a transmitter to transmit the signal having the information from the object.

26. The system of claim 24 further comprising a display module in communication with the processor to display the image showing the information superimposed on the video image.

27. A system for providing information into a video record from an object in a monitored area, comprising:
a sensor having a plurality of pixels, each pixel configured to generate an electrical signal in response to an optical data signal emitted by an optical tag and incident on the pixel, the plurality of pixels providing video image data for the monitored area; and
a processor in communication with the sensor, the processor determining the information from at least one of the electrical data signals and generating image data for an image showing the information superimposed on the video image.

28. The system of claim 27 wherein the sensor and the processor comprise an optical communications imager.

29. The system of claim 27 wherein the sensor comprises a digital video camera.

30. The system of claim 27 wherein the sensor comprises an analog video camera in electrical communication with a frame grabber.
